(19) United States
(12) Patent Application Publication
(10) Pub. No.: US 2016/0207229 A1
(43) Pub. Date: Jul. 21, 2016

(54) FILM RETAINER AND TENTER APPARATUS

(71) Applicant: UBE INDUSTRIES, LTD., Ube-shi, Yamaguchi (JP)

(72) Inventors: Hiroyuki IKEUCHI, Ube-shi (JP); Gouhei YAMAMOTO, Ube-shi (JP); Kazutaka NARITA, Ube-shi (JP)

(73) Assignee: UBE Industries, Ltd., Ube-shi, Yamaguchi (JP)

(21) Appl. No.: 14/911,458

(22) PCT Filed: Aug. 14, 2014
(86) PCT No.: PCT/JP2014/071449

§ 371 Date: Feb. 10, 2016

(30) Foreign Application Priority Data
Sep. 4, 2013 (JP) 2013-183378

(51) Int. Cl. B29C 39/38; B65H 23/022; B29C 39/14

(52) U.S. Cl. CPC B29C 39/38; B29C 39/14; B65H 23/022; B29K 2079/08

(57) ABSTRACT

In an embodiment, a film retainer 200 includes a base member 210 fixed to a tenter chain and a pin plate 220 supported on the base member 210 to be movable in the movement direction of the tenter chain. The pin plate 220 is provided with a plurality of protruding pins 230 that are stuck into the film for holding the film. The film retainer for a tenter apparatus is capable of suppressing a bowing phenomenon without significant modifications to an existing manufacture facility and being applicable under arbitrary manufacture conditions.

### TECHNICAL FIELD

The present invention relates to a film retainer for holding a film at both ends in a transverse direction provided for a tenter apparatus used in continuous film transport during a process of manufacturing a film, for example, a polyimide film.

### BACKGROUND ART

Films are used in a variety of fields, and various types of films are present for different uses or the like. Among them, polyimide films are widely used in various fields due to light weight and excellent properties including high flexibility, mechanical strength, and heat resistance, particularly in electronics and electrical fields, for example as materials for flexible wiring substrates and materials for COF substrates.

In recent years, electrical and electronic devices such as computers have been increasingly reduced in size and weight, and accordingly, materials for wiring substrates and IC packages used in those devices need to have reduced size and weight. Wiring patterns produced on those components also have become finer and finer. Thus, films used in such materials for wiring substrates and IC packages require high dimension stability over the entire width direction.

Among the films, polyimide films are difficult to be melt-processed and can be manufactured, for example by casting a polyimide precursor organic solvent solution such as polyamic acid onto a support such as a belt or a drum to provide a self-supporting film (also referred to as a gel film) and then continuously heat-treating the film while the film is transported with both ends in a transverse direction held by a tenter apparatus.

In the above manufacture method, both ends of the film in the transverse direction are fixed and held by a film retainer provided for the tenter apparatus in a heating apparatus for performing continuous heat treatment. When the continuous heat treatment of the film is performed with both ends of the film in the transverse direction held, the film undergoes extension and shrinkage to different degrees between both ends and the center in the transverse direction. This is because the extension and shrinkage of the film at both ends of the film in a machine direction are restrained by the film retainer, whereas the restraint force by the film retainer is relatively low at the center.

During transverse direction stretching of the film, by way of example, the film has different statuses of machine direction shift between both ends and the center in the transverse direction. The different statuses of machine direction shift between both ends and the center of the film in the transverse direction can be checked, for example by drawing a straight line on a surface of the film along the transverse direction before transport and then observing deformation of the straight line.

Specifically, in the heating apparatus for continuous heat treatment, the straight line is deformed in a convex shape viewed from the downstream side of the film in the machine direction in an initial area of transverse direction stretching. This means that the center of the film shifts faster in the machine direction than both ends. Then, the line deformed in the convex shape gradually returns to the straight line, and is deformed in a concave shape after the transverse direction stretching is completed. The different statuses of shift are thought to be due to machine direction extension stress of the film produced during the transverse direction stretching or the machine direction shrinkage stress of the film produced from imidization.

As a result of the shrinkage, the manufactured film has the concave deformation remaining therein. This phenomenon is referred to as a bowing phenomenon. Particularly in the heating apparatus for continuous heat treatment, the bowing phenomenon is significantly observed when the film is stretched in the transverse direction by adjusting a space interval between rails of the tenter apparatus to increase a transverse direction space interval between the film retainers. The bowing phenomenon produces anisotropy of molecular orientation in a film width direction, which causes unevenness of mechanical properties, moisture expansion coefficient, thermal expansion coefficient, and thermal shrinkage coefficient to present problems including reduced product yields.

Such property variations in the film plane create quality differences, particularly dimensional differences, depending on positions and directions in the film plane during film processing. This may lead to partial warpage or curl to cause a serious problem in uses for precision parts such as base materials in circuit formation and recording media. Thus, technical improvement is needed for ensuring isotropy of properties over the entire width direction of the film.

At the continuous heat treatment step in the heating apparatus, it is known that films exhibit a complicated phenomenon including shrinkage and extension in the machine direction associated with changes in dryness, molecular orientation state, and imidization rate. When a film is held by sticking a pin serving as a film retainer into the film, the shrinkage stress or the extension stress may enlarge the hole in the film into which the pin is stuck. If the film is cut at this position, the film may have reduced flatness, varying levels of quality, and reduced productivity.

Examples of a means for suppressing the bowing phenomenon in polyimide films include a method of observing the occurrence of the bowing phenomenon in a film and then determining the temperature in a heating apparatus (see Patent Document 1), a method of avoiding heating of a film to the boiling point or higher of a main volatile content from a film fixing end at a tenter apparatus inlet to a point at a length in a travel direction within a heating apparatus that corresponds to a film width (see Patent Document 2), a method of stretching a gel film in a machine direction by a factor of 1.1 to 1.9 at a temperature of 150° C. or lower and then stretching the film in a transverse direction by a factor 0.9 to 1.3 times higher than the factor in the machine direction at a temperature of 400° C. or lower (see Patent Document 3), a method of fixing a gel film at both ends with the film relaxed (see Patent Document 4), a method of forcedly moving backward the center of a gel film in a transverse direction by a nip roll applying a load to the center (see Patent Document 5), and a method of forming a tenter chain with an extension/shrinkage mechanism including a plurality of links coupled in a staggered form such that the extension/shrinkage mechanism is extended as a space interval between a pair of tenter rails is increased, thereby increasing a space interval in a machine direction between held portions of a film (see Patent Document 6).

### PRIOR ART REFERENCES

### Patent Document

Patent Document 1: Japanese Patent Laid-Open No. 2002-154168
Patent Document 2: Japanese Patent Laid-Open No. 1996-230063
Patent Document 3: Japanese Patent Laid-Open No. 1993-2379238
Patent Document 4: Japanese Patent Laid-Open No. 2006-181986
Patent Document 5: Japanese Patent Laid-Open No. 2007-22042
Patent Document 6: Japanese Patent Laid-Open No. 2012-81702

### SUMMARY OF INVENTION

### Problems to be Solved by the Invention

In the methods disclosed in Patent Documents 1 to 3, however, the heating temperature or the stretching factor of the film is limited, so that those technologies are not applicable depending on film manufacture conditions. In the method disclosed in Patent Document 4, it is important to relax the film with fixed dimensions in order to achieve stable the distribution of molecular orientation and mechanical properties, but it is difficult to relax the film with such fixed dimensions. In the method disclosed in Patent Document 5, the nip roll presses the center of the film in the transverse direction, so that a film surface may be damaged by the nip roll.

A tenter apparatus disclosed in Patent Document 6 is different in the tenter chain structure from a typical tenter chain. To apply it to an existing facility, the tenter chain and all the associated parts should be replaced, which requires extremely high cost and enormous effort.

It is an object of the present invention to provide a film retainer for holding a film at both ends in a transverse direction during transport of the film in a machine direction for continuous manufacture, the film retainer being capable of suppressing the bowing phenomenon without significant changes in an existing manufacture facility, being applicable under arbitrary manufacture conditions, and being suitable for sequential stretching, as well as a tenter apparatus using the film retainer, and a method of manufacturing a polyimide film using the tenter apparatus.

### Means for Solving the Problems

The present invention provides a film retainer fixed to a pair of tenter chains included by a tenter apparatus, the tenter chain moving while holding a film at both ends in a transverse direction, including:

a base member fixed to the tenter chain; and at least one pin plate supported on the base member to be movable in a direction of the movement of the tenter chain and provided with a plurality of protruding pins adapted to stick into the film for holding the film.

The film retainer according to the present invention preferably includes at least one elastic support member elastically supporting the pin plate on the base member in the movement direction of the tenter chain. The elastic support member may be a coil spring. The film retainer can be configured to include a plurality of the pin plates placed at a space interval in the movement direction of the tenter chain. As a structure for movably supporting the pin plate, the pin plate can include a flat-plate portion provided with the plurality of protruding pins on a front face, a projecting portion protruding from a back face of the flat-plate portion, and an anchor portion extending in parallel to the flat-plate portion with a space interval in a thickness direction of the flat-plate portion across the leg portion, and the base member can include a removal-preventing projecting portion extending between the flat-plate portion and the anchor portion. As another structure for movably supporting the pin plate, at least one bearing rotatably supported on a back face side of the pin plate may be included.

The present invention provides a tenter apparatus including a pair of tenter chains placed on both sides of a transport path of a film for transporting the film; and

a plurality of the film retainers according to the present invention as described above, the film retainers being fixed to each of the pair of tenter chains.

The present invention provides a method of manufacturing a polyimide film, including a first step of casting a polyimide precursor solvent solution onto a support to provide a self-supporting film; and

a second step of heating the self-supporting film while the film is held,

the second step includes holding the self-supporting film as the film by using the tenter apparatus according to the present invention as described above.

### Effect of the Invention

According to the present invention, the use of the movable-type pin plate can reduce the difference in restraint force between the film ends and the film center to significantly reduce the bowing distortion and the anisotropy of molecular orientation at the film ends as compared with the use of the fixed-type pin plate. Since this can produce the polyimide film having uniform properties in the transverse direction, the product yields can be enhanced. The use of the movable-type pin plate can produce the polyimide film having better flatness as compared with the use of the fixed-type pin plate. In addition, he film retainer according to the present invention can be provided by easily modifying an existing tenter apparatus, and can be preferably used, especially for sequential stretching.

### BRIEF DESCRIPTION OF DRAWINGS

FIG. 1 is a plan view of a tenter apparatus according to an embodiment of the present invention.

FIG. 2 is a diagram showing enlarged portion II of a tenter chain shown in FIG. 1.

FIG. 3 is a side view representing the tenter chain shown in FIG. 2 viewed from the side of a film retainer and part of an outer plate in cross section.

FIG. 4 is a section view of the tenter chain shown in FIG. 2 along line IV-IV.

FIG. 5 is a perspective view of the film retainer according to an embodiment of the present invention.

FIG. 5A is a plan view of the film retainer shown in FIG. 5.

FIG. 5B is a side view of the film retainer shown in FIG. 5.

FIG. 5C is a section view of the film retainer shown in FIG. 5 along line 5C-5C.

FIG. 6A is a diagram showing the operation of the film retainer shown in FIG. 5 and representing the state where the space interval between two adjacent film retainer is reduced.

FIG. 6B is a diagram showing the operation of the film retainer shown in FIG. 5 and representing the state where the space interval between two adjacent film retainer is increased.

FIG. 7A is a plan view of a film retainer according to another embodiment of the present invention.

FIG. 7B is a side view of the film retainer shown in FIG. 7A.

FIG. 8 is a perspective view of a film retainer according to yet another embodiment of the present invention.

FIG. 8A is a perspective view of the film retainer shown in FIG. 8 including two bearings.

FIGS. 9(a)-9(c) are diagrams for describing a movable range of the film retainer shown in FIG. 8.

FIG. 10A is a side view of an end portion of a pin of a lancet point type preferably used in the present invention.

FIG. 10B is a front view of the pin shown in FIG. 9A.

FIG. 11 is a diagram showing a film held by a jig in an experiment conducted to verify the effects of the present invention.

FIG. 12 is a diagram for describing an expression for calculating bowing distortion in the experiment conducted to verity the effects of the present invention.

FIG. 13 is a diagram showing cutting positions and directions of samples for measuring the CTE of the film in the experiment conducted to verity the effects of the present invention.

FIG. 14A is a CTE radar chart at a film left end in Comparative Example 1 provided to verity the effects of the present invention.

FIG. 14B is a CTE radar chart at the film center in Comparative Example 1 provided to verity the effects of the present invention.

FIG. 14C is a CTE radar chart at a film left end in Example 1 provided to verity the effects of the present invention.

FIG. 14D is a CTE radar chart at the film center in Example 1 provided to verity the effects of the present invention.

FIG. 14E is a CTE radar chart at a film left end in Example 2 provided to verity the effects of the present invention.

FIG. 14F is a CTE radar chart at the center end in Example 2 provided to verity the effects of the present invention.

### DESCRIPTION OF EMBODIMENTS

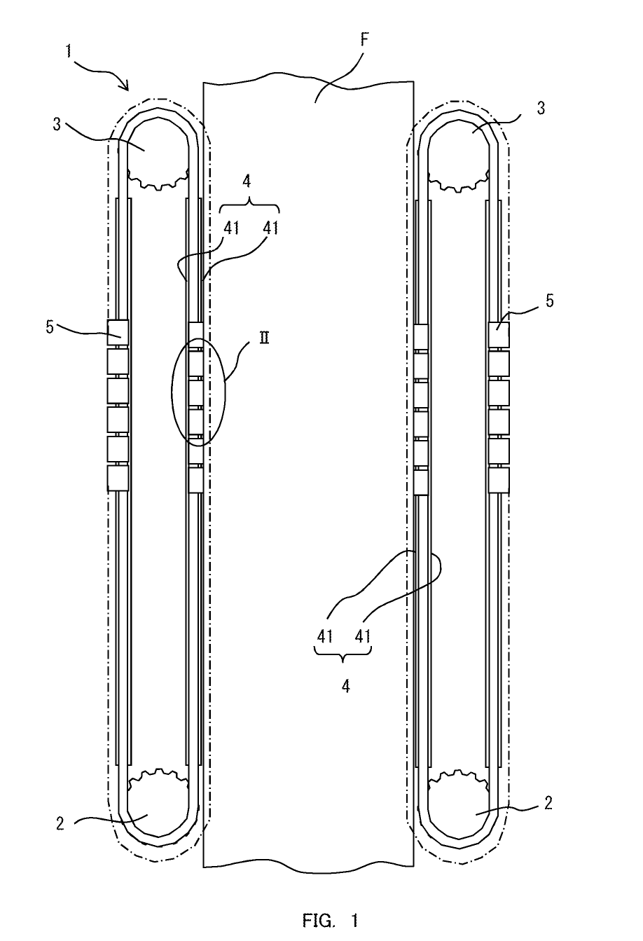

Referring to FIG. 1, an exemplary tenter apparatus is shown which is used in a process of manufacturing a polyimide film, and particularly, which transports a self-supporting film while holding its both ends in a width direction during heat treatment of the self-supporting film. In the following description of the tenter apparatus, the self-supporting film is represented as “film F” for simplicity.

Tenter apparatus 1 includes a pair of tenter chains 5 placed on both sides of a transport path of film F and a pair of tenter rails 4 for guiding movement of tenter chains 5. Each tenter chain 5 is formed to be endless and engages with drive sprocket 2 and driven sprocket 3. Tenter rail 4 extends along a transport direction of film F and includes a pair of guide plates 41 placed in parallel. Tenter chain 5 can pass between guide plates 41.

Each tenter chain 5 includes a plurality of film retainers as described later in detail. Film F is held at both ends by the film retainers provided for each tenter chain 5. When drive sprocket 2 is driven while film F is held at both ends in the width direction, tenter chain 5 is moved along tenter rail 4 and thus film F is transported.

In tenter apparatus 1 shown in FIG. 1, paired tenter rails 4 are placed in parallel so as to transport film F at a fixed width. Alternatively, tenter rails 4 can be placed such that a space interval between them is increased or reduced toward downstream in the transport direction of film F. Increasing the interval between tenter rails 4 toward downstream in the transport direction of film F enables transverse direction stretching of film F. Conversely, gradually reducing the interval between tenter rails 4 toward downstream in the transport direction of film F can relax stress in film F. Alternatively, paired tenter rails 4 can be placed to have a combination of two or more of an area having a fixed interval, an area having a gradually increased interval, and an area having a gradually reduced interval.

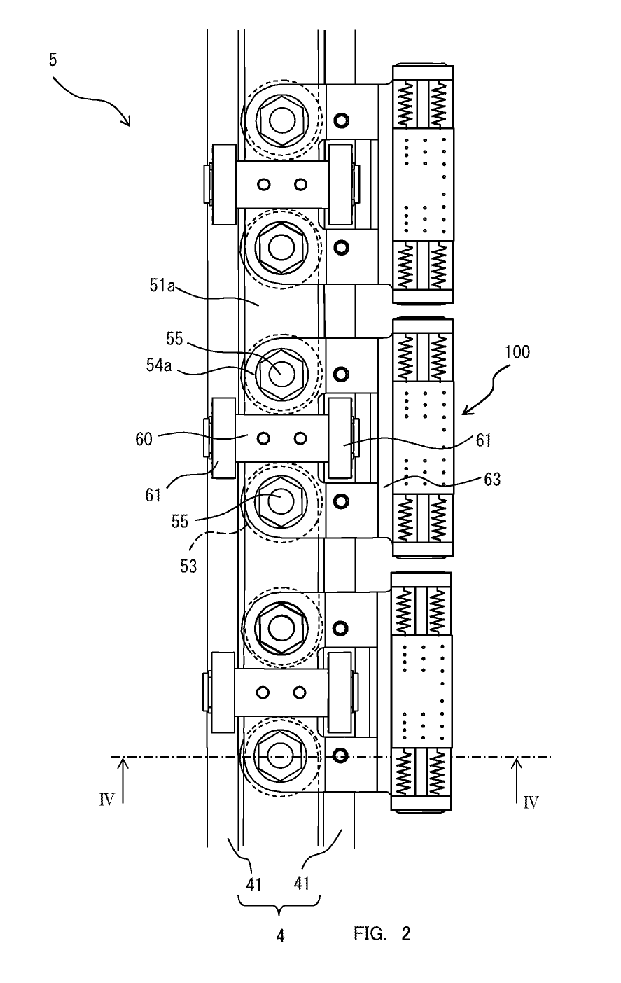

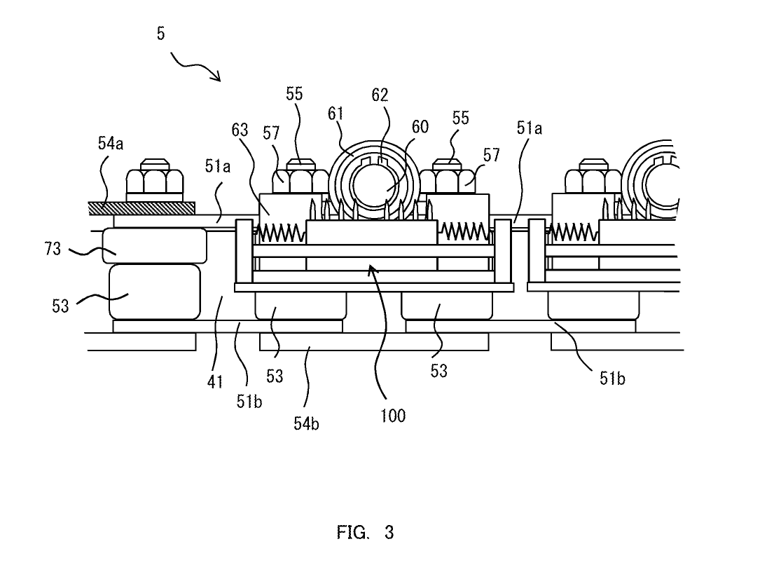

Next, tenter chain 5 is described in detail bellow with reference to FIG. 2 to FIG. 4.

Tenter chain 5 is a roller chain which is endless by alternately coupling a plurality of inner links to a plurality of outer links. The inner link includes a pair of inner plates 51a, 51b oppositely placed, two bushes 52 coupling them, and two rotators (second rotators) 53, 73 rotatably supported on the outer periphery of bushes 52 between inner plates 51a, 51b. Inner plates 51a, 51b are members formed to have a longitudinal direction, and two bushes 52 are placed at an interval in the longitudinal direction. Rotator 73 is located between paired guide plates 41 in the width direction of film F and adjacent to guide plates 41, and rotator 73 has a diameter smaller than an interval between paired guide plates 41 and larger than the width of inner plate 51a and/or 51b to allow contact with guide plates 41.

Rotators 53, 73 are placed along an axial direction of bush 52 coupling inner plates 51a, 51b and are supported on the outer periphery of bush 52 to be rotatable independently. As described above, the tenter chain engages with drive sprocket 2 and driven sprocket 3 (see FIG. 1) and is operated when drive sprocket 2 is driven to rotate. As in the present embodiment, rotators 53, 73 placed in two, upper and lower, layers can be provided such that one rotator 53 has the function of engaging with drive sprocket 2 and driven sprocket 3 and the other rotator 73 has the function of contacting guide plates 41 on the outer peripheral face. Thus, the tenter chain can have sufficient durability for use over a long period.

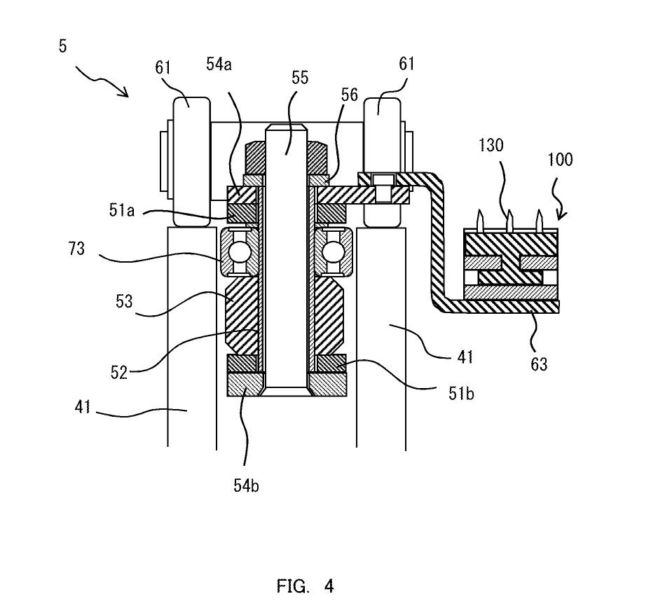

As shown in FIG. 4, rotator 73 having the function of contacting guide plates 41 can be a rolling bearing. This allows operation with a smaller driving force, reduced production of metal wear powder, and reduced noise during operation. Rotator 53 having the function of engaging with drive sprocket 2 and driven sprocket 3 does not need to be a rolling bearing, and for example, can be a roller supported rotatably about the axis as shown in FIG. 4. Due to no need of contact with guide plates 41, rotator 53 has a diameter smaller than the diameter of rotator 73 and the diameter may be equal to or smaller than the width of inner plate 51a and/or 51b.

The outer link includes a pair of outer plates 54a, 54b oppositely placed outside the inner link, and two coupling pins 55 extending through inner plates 51a, 51b and bushes 52 for coupling outer plates 54a, 54b to the inner link. Outer plates 54a, 54b are members formed to have a longitudinal direction and have a length capable of coupling two adjacent inner inks. In the present embodiment, coupling pin 55 is a screwed pin and is held by washer 56 and nut 57 to prevent removal of coupling pin 55 from outer plates 54a, 54b.

Attach plate 63 is fixed to outer plate 54a of paired outer plates 54a, 54b that is located at an upper level. Attach plate 63 is attached to one face of outer plate 54a such that attach plate 63 extends toward one side of tenter chain 5 in a width direction perpendicular to the longitudinal direction of outer plate 54a.

In the present embodiment, as shown in FIG. 4, outer plate 54a to which attach plate 63 is attached has a shape partially extended toward the side on which film retainer 100 is placed in order to ensure a margin for attachment of attach plate 63, and attach plate 63 is attached to the end of the extended portion.

Film retainer 100 for holding film F by sticking film F with a plurality of pins 130 is fixed to the end of attach plate 63. Film retainer 100 is described later in detail.

Attach plate 63 can have any shape as long as film retainer 100 can be located on one side of outer plate 54a in the width direction. In the present embodiment, attach plate 63 is formed to have a crank-shaped cross section such that the end thereof to which film retainer 100 is attached is located between opposite outer plates 54a, 54b and extends in parallel to outer plates 54a, 54b.

Shaft member 60 is fixed to outer plate 54a to which attach plate 63 is fixed, such that the axial direction of shaft member 60 is in parallel to the width direction of outer plate 54a, in other words, in parallel to a transport plane of film F and extends perpendicularly to the longitudinal direction of tenter rail 4. Shaft member 60 is a stepped member having a smaller diameter at both ends than that of the remaining portion. Bearing 61 for supporting a radial load of shaft member 60 is provided as a rotator and placed on the portion having the smaller diameter to be rotatable about shaft member 60.

Two bearings 61 attached to both ends of shaft member 60 are designed to have an interval between them substantially equal to the interval between guide members 41 such that bearings 61 can be supported on upper faces of paired guide plates 41. The axial position of bearing 61 relative to shaft member 60 is fixed, for example by C washer 62.

Bearing 61 can be provided by using any bearing including a rolling bearing and a sliding bearing that supports the radial load, and the rolling bearing is used in the present embodiment. The rolling bearing includes an outer race, an inner race, a plurality of rolling elements (ball) placed between the outer race and the inner race, and a spacer for spacing the rolling elements in a circumferential direction. The inner race is fixed to shaft member 60, and the outer race rotates relative to shaft member 60.

Since bearings 61 are provided as described above, tenter chain 5 is supported on tenter rail 4 to be movable in the longitudinal direction of tenter chain 5 by bearing 61.

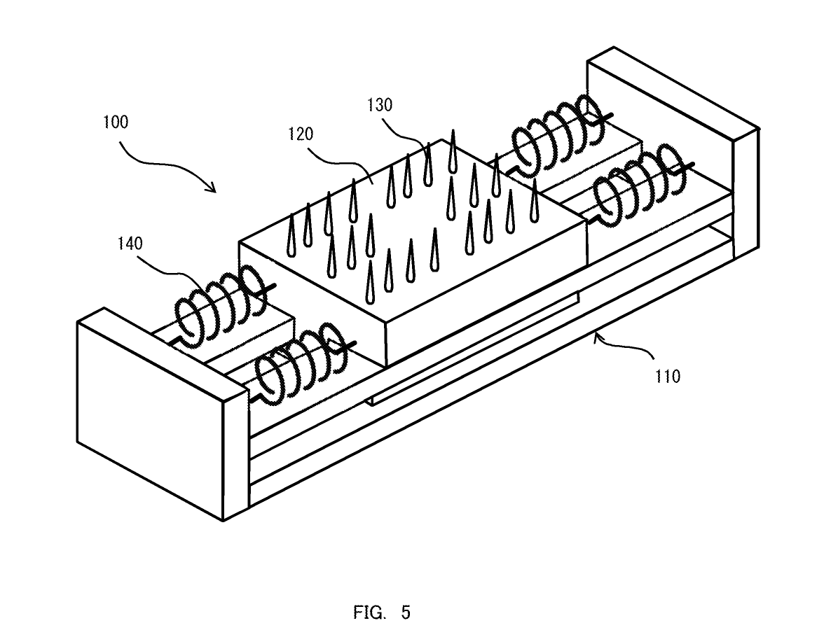

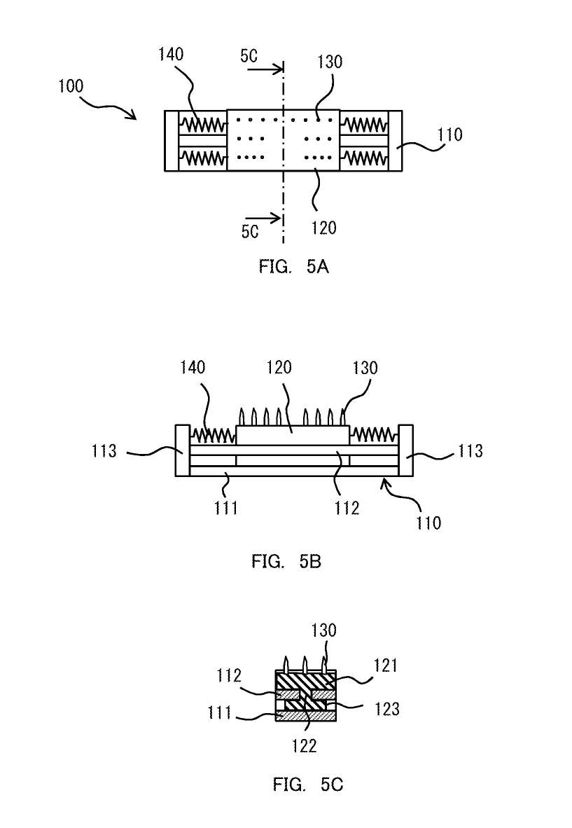

Next, film retainer 100 is described in more detail with reference to FIG. 5 and FIG. 5A to FIG. 5C.

Film retainer 100 includes base member 110 and pin plate 120, and base member 110 is fixed to attach plate 63. The fixing of base member 110 to attach plate 63 is performed in any method, but the fixing is preferably performed by screws so as to facilitate mounting and demounting for maintenance or in replacement with a conventional film retainer.

A plurality of pins 130 are provided to protrude on pin plate 120. Those pins 130 are stuck into film F to hold film F at both ends in the width direction. This held film F is transported by operation of tenter chain 5.

Pin plate 120 is supported on base member 110 to be movable in the moving direction of tenter chain 5. To movably support pin plate 120 on base member 110, base member 110 and pin plate 120 can have an arbitrary guide structure such as a combination of a projection and a depression extending in the moving direction of pin plate 120.

Next, the guide structure is described with reference to film retainer 100 shown. For directions referred to in the present invention, the direction in which pin plate 120 moves relative to base member 110 is referred to as a “machine direction,” the direction perpendicular to the machine direction in a plane on which film F is held is referred to as a “transverse direction,” and the direction perpendicular to the machine direction and the transverse direction is referred to as a “vertical direction.”

Pin plate 120 includes flat-plate portion 121 provided with the plurality of protruding pins 130 on a front face, projecting portion 122 protruding from a back face of flat-plate portion 121, and anchor portion 123 provided at the end of projecting portion 122. Projecting portion 122 may be formed to span the entirety or a portion of flat-plate portion 121 in the machine direction. Anchor portion 123 is placed in parallel to flat-plate portion 121 in the machine direction with an interval interposed between them in the vertical direction. Although anchor portion 123 may have any dimension in the machine direction, anchor portion 123 has a dimension in the transverse direction larger than a dimension of projecting portion 122 in the transverse direction.

The number and the placement of pins 130 protruding from the front face of flat-plate portion 121 are not limited particularly as long as they can reliably hold ends of film F, and the same number of pins per unit area and the same placement of pins as those in conventional film retainers may be used. The diameter, angle, shape, and material of pin 130 may be the same as those of conventional ones.

In contrast, base member 110 includes base plate 111 fixed to attach plate 63 (see FIG. 4), two end plates 113 fixed to both ends of base plate 111 in the machine direction, and two linear guides 112 placed between two end plates 113 and fixed to end plates 113.

Base plate 111 is a flat-plate member and is preferably formed in a rectangular shape conforming to the fixing face of attach plate 63. Linear guide 112 is a rod-shaped member having the same machine direction length as base plate 111 and extending in the machine direction, and is located with an interval from base plate 111 in the vertical direction. Two linear guides 112 are located in parallel to each other with an interval in the transverse direction between them, and both ends thereof in the machine direction are supported on end plates 113. The interval between linear guides 112 is set to allow projecting portion 122 of pin plate 120 to be placed between two linear guides 112. The interval between base plate 111 and linear guides 112 is set to allow anchor portion 123 of pin plate 120 to be placed between base plate 111 and linear guides 112. Linear guide 112 has an arbitrary sectional shape but preferably has a rectangular section.

Since base member 110 is formed in this manner, pin plate 120 can be supported to be movable in the machine direction without coming off base member 110 even the film is under the tension in the transverse direction.

Film retainer 100 can further include coil springs 140 in order to locate pin plate 120 at a predetermined position on base member 110 while no external force is applied to pin plate 120. To this end, in the present embodiment, two coil springs 140 are placed on each side of pin plate 120 in the moving direction thereof such that the ends of each coil spring 140 are put on pin plate 120 and end plate 113. This causes pin plate 120 to be held at the predetermined position relative to base member 120 in the machine direction while no external force is applied other than from coil spring 140. Coil spring 140 may be an extension coil spring or a compression coil spring.

Although the material for coil spring 140 is not limited particularly, heat-resistant steel or stainless steel can be preferably used, and among them, stainless steel can be used more preferably.

The spring constant of coil spring 140 is not limited particularly and can be set approximately at such a level that pin plate 120 can be returned to the original position when an external force is released after it is applied to and moves pin plate 120. Examples of particular values may be from 0.1 to 15 N/mm, and preferably, from 0.2 to 7 N/mm. When coil spring 140 is used to elastically support pin plate 120 in this manner, coil spring 140 preferably has the smallest possible spring constant to prevent coil spring 140 from hindering the movement of pin plate 120 on base member 110.

Coil springs 140 may be placed only on one side of pin plate 120 in the moving direction thereof if pin plate 120 can be held at the predetermined position while no external force is applied to pin plate 120. However, to enhance the accuracy in positioning pin plate 120, coil springs 140 are preferably placed on both sides of pin plate 120 in the moving direction.

The number of coil springs 140 may be one or plural and is not limited particularly. When the number of coil spring 140 is one, coil spring 140 is placed only on one side of pin plate 120 in the moving direction. When the number of coil springs 140 is plural, coil springs 140 may be placed on both sides or only one side of pin plate 120 in the moving direction. Although two coil springs 140 are placed in parallel in the transverse direction of pin plate 120 in the present embodiment, this arrangement is employed to allow one coil spring 140 to perform the function of elastically supporting pin plate 120 even when the other coil spring 140 experiences fatigue failure due to repeated operations of pin plate 120.

Although the present embodiment has shown the example in which coil spring 140 is used as an elastic support member, the present invention is not limited to the use of coil spring 140, and an arbitrary elastic support member capable of elastically supporting pin plate 120 on base member 110 in the moving direction of the tenter chain can be used such as a leaf spring and a torsion spring. When the elastic support member other than coil spring 140 is used, the spring properties, placement, and number of the elastic support members may be determined based on the same consideration as those for coil springs 140.

The elastic support member has been described which returns pin plate 120 to the predetermined position relative to base member 110 while no external force is applied to pin plate 120. However, the means for returning pin plate 120 to the predetermined position relative to base member 110 is not limited to the elastic support member using the elastic force of the spring but may be a different arbitrary mechanism. For example, at least part of pin plate 120 can be made of a paramagnetic substance so that pin plate 120 can be returned to the predetermined position by using a magnet. Alternatively, the tenter rail can be inclined relative to the vertical direction forward of the position of the film held by film retainer 100 so that pin plate 120 can be returned to the predetermined position by gravitation.

When another mechanism for positioning pin plate 120 relative to base member 110 is included, the elastic support member can be omitted.

Each of the components constituting tenter chain 5 can be made of stainless steel or the like, similarly to a typical tenter chain.

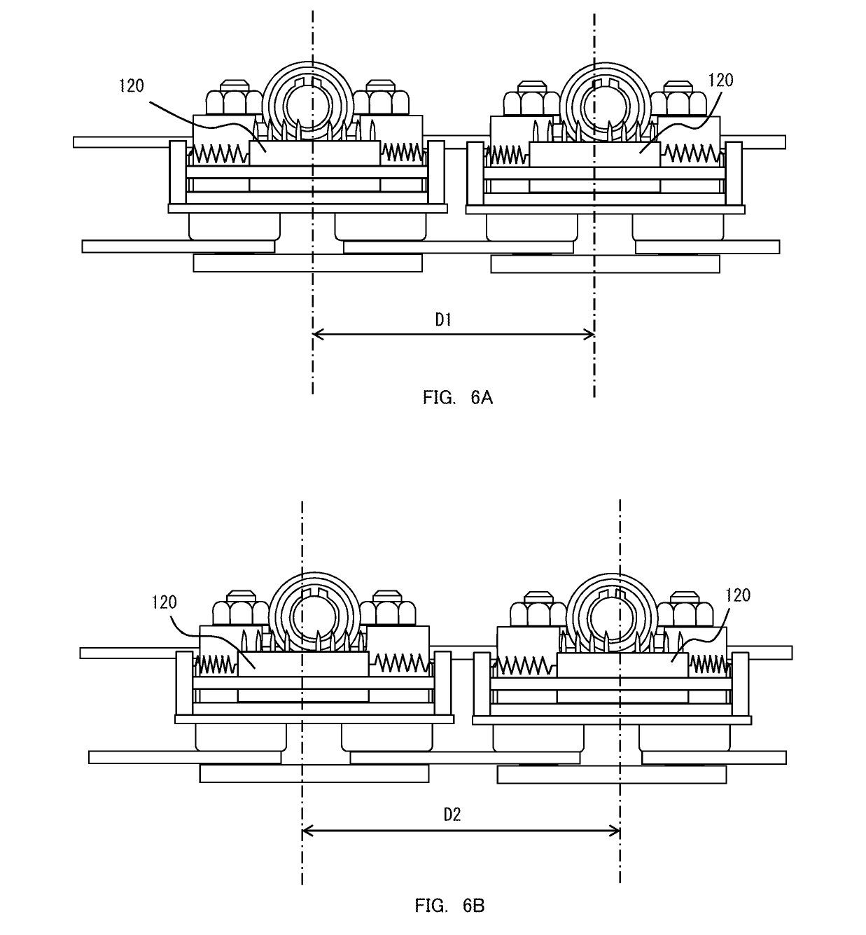

Pin plate 120 is supported to be movable in the machine direction as described above. When a shrinkage force in the machine direction acts on film F during transport of film F, the shrinkage force reduces distance D1 between pin plates 120 adjacent to each other in the machine direction as shown in FIG. 6A. In contrast, when an extension force in the machine direction acts on film F, the extension force increases distance D between pin plates 120 adjacent to each other in the machine direction as shown in FIG. 6B. As a result, film F can be extended and contracted within the movable range of pin plate 120 depending on the extension/shrinkage force acting on film F not only at the center but also at both ends of film F. This can eliminate various problems due to the bowing phenomenon such as anisotropy of orientation angle, and unevenness of mechanical properties, moisture expansion coefficient, thermal expansion coefficient, and thermal shrinkage to achieve favorable isotropy of properties of film F. Film retainer 100 allows the manufacture of the film under desired temperature conditions and by desired stretching factors without requiring setting of particular temperature conditions or stretching factors for reducing the bowing phenomenon. In addition, since pin plate 120 can be moved freely in the machine direction depending on the extension stress or shrinkage stress in the machine direction of the film, extreme stress does not tend to be applied to the portion of the film into which the pin is stuck and thus the film is never torn at the pin stick portion, thereby improving the film productivity.

Since pin plate 120 can be attached to attach plate 63 (see, for example, FIG. 4) provided for a typical tenter chain by replacement for a conventional pin sheet, most of an existing facility can be used, and modifications to provide the tenter apparatus to which the present invention is applied can be made with minimum effort. In addition, the film retainer according to the present invention can be preferably used in a tenter apparatus for sequential stretching.

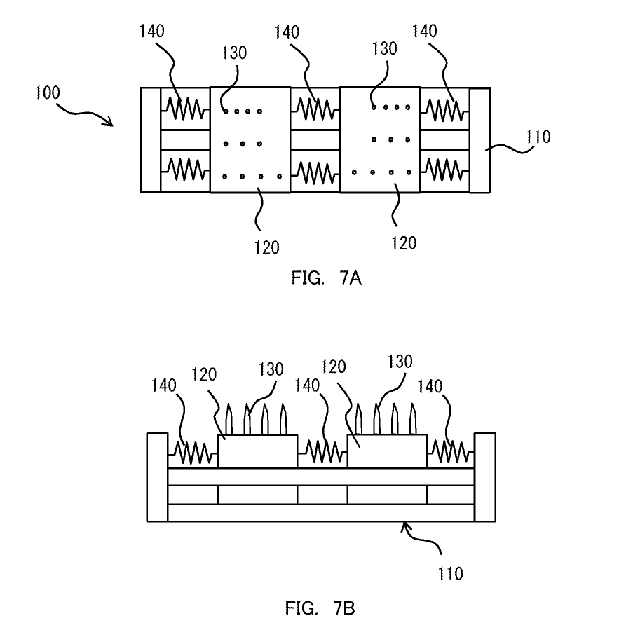

FIG. 7A and FIG. 7B show another embodiment of film retainer 100. Film retainer 100 in the present embodiment differs from the film retainer described above in that the former includes a plurality of pin plates 120. The plurality of pin plates 120 are placed along the machine direction of base member 110 and are supported on base member 110 to be independently movable in the machine direction. Although FIG. 7A and FIG. 7B show an example in which two pin plates 120 are placed, three or more pin plates 120 may be placed on one base member 110. Coil springs 140 serving as elastic support members are also placed between two adjacent pin plates 120, but coil springs 140 between pin plates 120 are not essential. The placement of the plurality of pin plates 120 allows film F to be extended and contracted more freely at both ends in the transverse direction, and consequently, the bowing phenomenon can be suppressed more effectively.

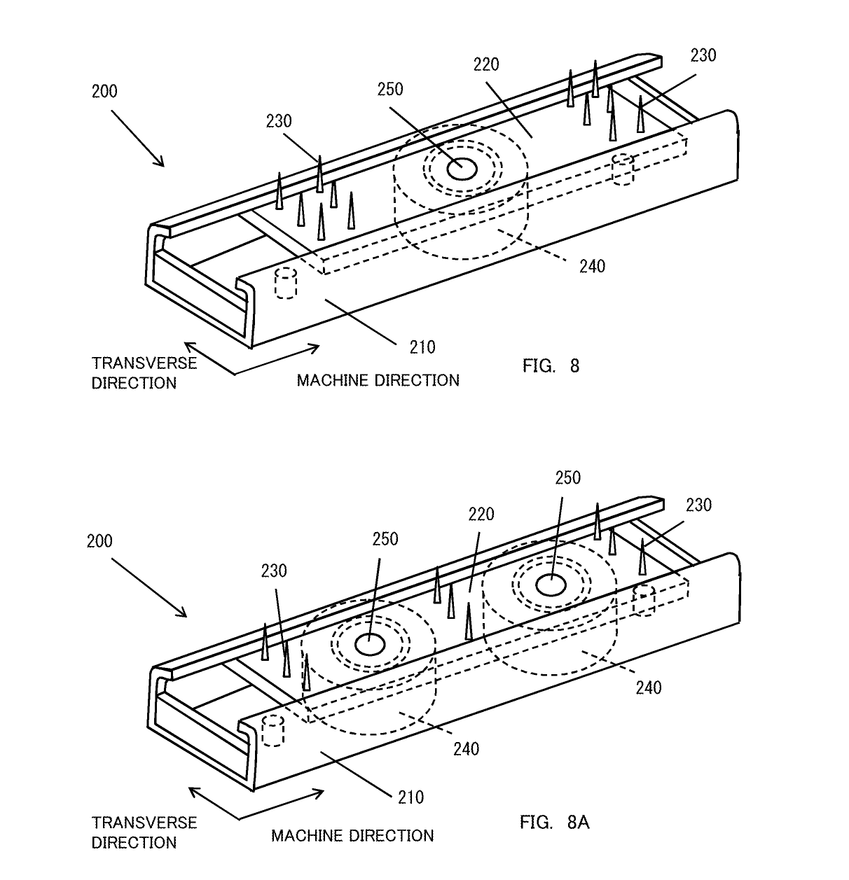

FIG. 8 shows yet another embodiment of the film retainer. Film retainer 200 shown in FIG. 8 includes base member 210 fixed to the tenter chain and pin plate 220 supported on base member 210 to be movable in the movement direction of the tenter chain and provided with a plurality of protruding pins 230 to be stuck into a film, similarly to the embodiment above.

Bearing 240 is rotatably supported on a back face of pin plate 220 (a face opposite to a face on which pins 230 protrude). Bearing 240 fixes rod member 250 placed to extend downward from pin plate 220 to pin plate 220, and bearing 240 is mounted on an outer peripheral face of rod member 250, so that bearing 240 is supported to be rotatable about an axis perpendicular to the moving direction of pin plate 220. In the present embodiment, to prevent pin plate 220 from coming off base member 210, walls of base member 210 on both sides in the transverse direction extend inward to cover both ends of pin plate 220 in the transverse direction.

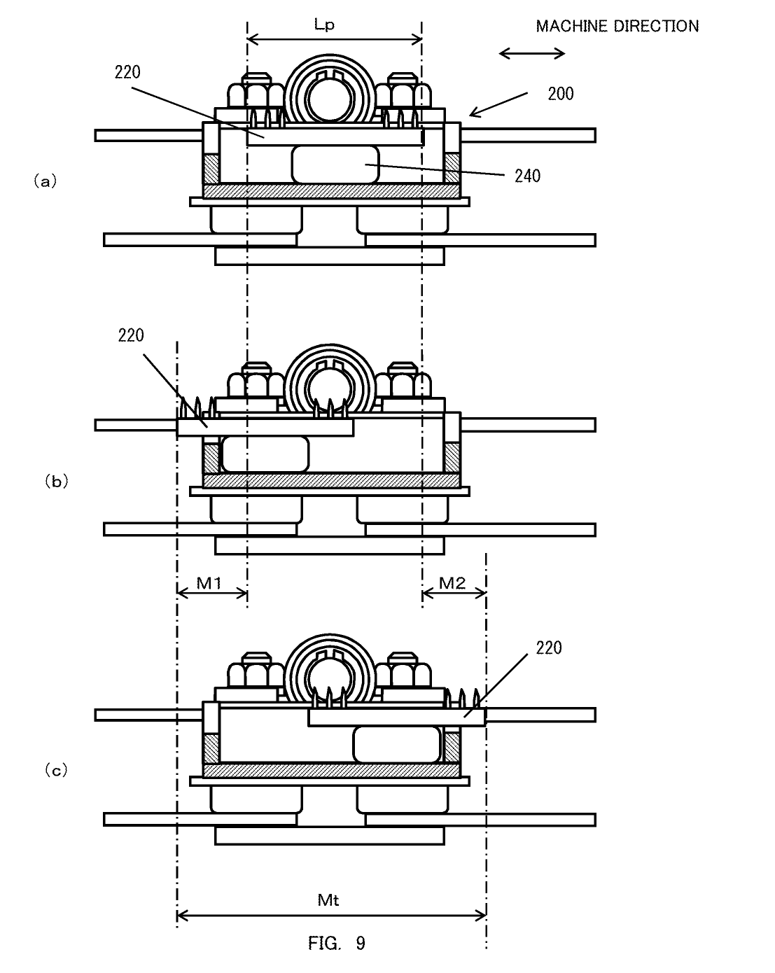

Bearing 240 has an outer diameter larger than the dimension of pin plate 220 in the transverse direction and smaller than the distance between side wall faces of base member 210 opposite to each other in the transverse direction. When a force in the machine direction acts on the film at both ends in the transverse direction while the film is held by film retainer 200, bearing 240 rolls in the machine direction on the side wall faces of base member 210 to move pin plate 220 in the machine direction as shown in FIG. 9(a) to FIG. 9(c). Since bearing 240 is rotatably attached to pin plate 220 in this manner, pin plate 220 can be moved more smoothly in the machine direction to result in effective suppression of the bowing phenomenon.

Bearing 240 may be a rolling bearing or a sliding bearing. The rolling bearing is preferable for smoother movement of pin plate 220 and higher durability of bearing 240. Especially for adaptation to high-temperature specifications, bearing 240 is preferably a heat-resistant bearing. An example of the heat-resistant bearing is a bearing lubricated with a solid lubricant. Since the use of bearing 240 lubricated with the solid lubricant eliminates the need to use a lubricating oil, film retainer 200 can be suitably used in a high-temperature environment.

This applies to all bearings used in the tenter apparatus when film retainer 200 is used in the tenter apparatus. Specifically, all the bearings used in the tenter apparatus can be provided by the bearing lubricated with the solid lubricant to make the tenter apparatus suitable for use in the high-temperature environment.

The number of bearings 240 used for one pin plate may be one as shown in FIG. 8 or two as shown in FIG. 8A. Alternatively, three or more bearings may be included. Film retainer 200 in the present embodiment can further include a mechanism for returning pin plate 220 to a predetermined position while no external force is applied to pin plate 220. Examples of the mechanism for returning pin plate 220 to the predetermined position include an elastic support member such as coil spring 140 shown in FIG. 5 or another type of spring, a configuration for returning pin plate 220 to the predetermined position with a magnetic force, and a configuration for returning pin plate 220 to the predetermined position with gravitation, similarly to those described in the above embodiment. Similarly to the embodiment described in FIG. 7A and FIG. 7B, the present embodiment can include two or more pin plates.

Referring again to FIG. 2 to FIG. 4, tenter chain 5 is used in such an orientation that the axial direction of coupling pin 55 extends vertically and outer plate 54a to which attach plate 63 is fixed is located at the upper level. Each tenter chain 5 is endless to have film retainers 100 facing outward and is engaged with drive sprocket 2 and driven sprocket 3. Each tenter chain 5 is supported on the upper faces of guide plates 41 by bearings 61 and roller 53 is located between guide plates 41 in the region where tenter rail 4 is installed.

Since paired tenter chains 5 are placed as described above, film retainers 100 face inward in the region where paired tenter chains 5 are opposite to each other. When the interval between tenter chains 5 is set appropriately in accordance with the width of film F, film F can be held at both ends by sticking pins 130 of opposite film retainers 100 into film F.

When drive sprocket 2 is driven with film F held at both ends, tenter chain 5 is moved to transport film F. The height of the held face of film F can be controlled through adjustment of the length or the bend angle of attach plate 63.

Tenter chain 5 moves with rolling of bearings 61 on guide plates 41. The inner link and the outer link are located between guide plates 41 to limit the position of tenter chain 5 in the transverse direction, so that tenter chain 5 is moved along tenter rail 4. The upper face of guide plate 41 is only required to have a structure which contacts bearing 61 and does not hinder the rolling of bearing 61, and preferably has a low friction against bearing 61. To this end, the upper face of guide plate 41 is preferably flat or smooth. The upper face of guide plate 41 may be subjected to surface treatment for reducing the friction against bearing 61.

### <Polyimide Film>

The polyimide film which can be manufactured according to the present invention is continuously manufactured with a manufacture method including a first step of casting a polyimide precursor organic solvent solution onto a support such as a belt or a drum to provide a self-supporting film and a second step of heating the film for the purpose of imidization and/or heat treatment while the film is held by the tenter apparatus in which the film retainer according to the present invention is installed. The polyimide film includes a polyimide film manufactured with a method using thermal imidization, chemical imidization, or a combination of thermal imidization and chemical imidization.

At the second step, the self-supporting film manufactured at the first step is subjected to heat treatment (thermal cure) to provide the intended polyimide film. In the present invention, the heating treatment is performed with the self-supporting film held at both ends in the width direction by the tenter apparatus described above.

The tenter apparatus used at the second step is preferably the apparatus described above. In the pin-type tenter apparatus described above, the self-supporting film is held at both ends stuck with the plurality of pins. The tenter apparatus holding the film is moved at a predetermined speed through a heating zone at a predetermined temperature to transport the film. During the transport, the film is heat-treated and the imidization proceeds, and finally, the polyimide film is provided.

At the second step, the heating is preferably performed gradually, for example over approximately 0.05 to 5 hours, under the condition that the highest temperature ranges from 200° C. to 600° C., preferably from 350° C. to 550° C., particularly preferably from 300° C. to 500° C. Preferably, to provide the final polyimide film containing 1 wt % or lower of volatile consisting of organic solvent, formed water and the like, such organic solvent and the like is sufficiently removed from the self-supporting film, and the polymer forming the film is fully imidized.

At the second step, the heating is performed at a tenter transport speed within the heating apparatus ranging from 1 to 15 m/min, and preferably, from 2 to 8 m/min.

In the present invention, the interval between the rails of the tenter apparatus can be adjusted to increase the interval between the film retainers in the transverse direction, thereby stretching the film in the transverse direction.

The heating can be performed by using various known heating apparatuses such as a hot-air oven and an infrared heating apparatus. The heating at an initial heating temperature, an intermediate heating temperature and/or a final heating temperature for the film is preferably performed in an atmosphere of inert gas such as nitrogen and argon or heating gas such as air.

The width of the polyimide film manufactured with the manufacture method described above is not limited particularly, but preferably ranges from 0.5 to 2 m. The thickness of the manufactured polyimide film can be selected as appropriate and is not limited particularly, but ranges from 5 to 150 μm, and preferably, from 8 to 50 μm.

The apparatus described and shown can be preferably used as the tenter apparatus. The details of the self-supporting film at the first step and the conditions in the heat treatment at the second step are as described above.

The present invention has been described with reference to the preferred embodiments. The present invention is not limited to the above embodiments, and arbitrary modifications are possible without departing from the spirit or scope of the technical ideas of the present invention.

For example, the sliding faces of at least one, preferably both, of the base member and the other member in contact with the base member when the pin plate is moved relative to the base member are preferably coated with molybdenum disulfide or tungsten disulfide, more preferably tungsten disulfide. This can reduce the sliding friction resistance during the movement of the pin plate to achieve smoother movement of the pin plate. The “other member” refers to the pin plate or the member attached to the pin plate, which is, in the embodiment described above, bearing 240 in the example shown in FIG. 8. The “sliding faces of the base member and the other member in contact with the base member” refer to, in the embodiment described above, the front face of linear guide 112 and the back face of pin plate 120 in the example shown in FIG. 5, the inner bottom face of base member 210 and the side faces of inner and outer races of bearing 240 in contact with base member 210 in the examples shown in FIG. 8 and FIG. 8A.

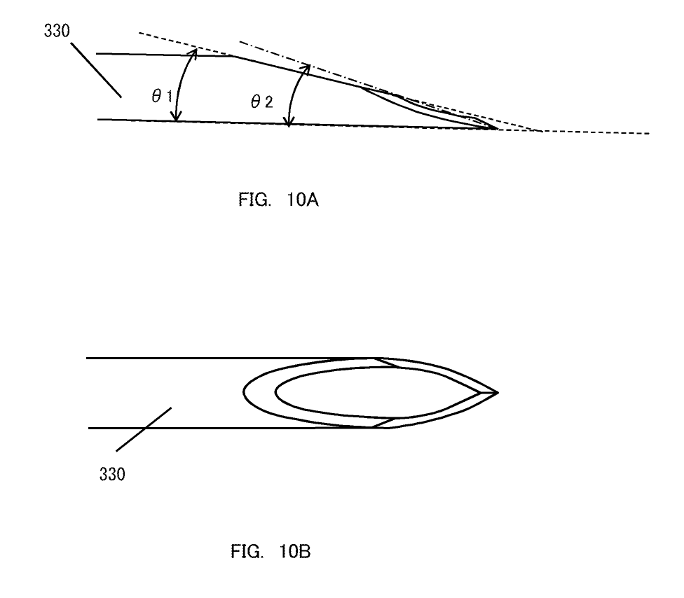

The shape of the pin is not limited particularly in the present invention and may have an arbitrary shape that can be stuck into the film. However, if a burr serving as a starting point of a tear is produced in the film when the film is stuck, the tear may enlarge from the burr depending on the direction of the burr and the film may fail to maintain proper tension. To address this, a needle of a lancet point type as shown in FIG. 10A and FIG. 10B is preferably used as pin 330. The lancet point type has a shape provided by obliquely cutting an end portion of a needle and then further obliquely cutting the tip of the cut end portion.

The use of pin 330 of the lancet point type can suppress tears in the film when the film is stuck. For pin 330 of the lancet point type, first angle θ1 corresponding to the cut angle in the first stage with respect to the axial direction of pin 330 is preferably 12°±1°, and second angle θ2 corresponding to the cut angle in the second stage is preferably 21°±2°.

The movement range of the pin plate in the machine direction relative to the base member may be arbitrarily set, but a preferable range is present for stable operation over the base member. For example, in film retainer 200 shown in FIG. 9, movable range Mt of pin plate 220 is represented as:

Mt=Lp+M1+M2

where Lp represents the length of pin plate 220 in the machine direction, and M1 and M2 (see FIG. 9(b) and FIG. 9(c), respectively) represent movable distances of pin plate 220 to both sides in the machine direction from an arbitrary position (for example, the position shown in FIG. 9(a)).

Assuming that Mt/Lp, provided by dividing movable range Mt by pin plate length Lp, is a pin plate movable rate, the pin plate movable rate is preferably 1.05 or higher. For example, when the manufacture of the polyimide film includes stretching of the film in the machine direction and then stretching in the transverse direction with a conventional tenter apparatus, approximately 5% of bowing distortion is typically expected to occur. The bowing distortion can be prevented more effectively by setting the pin plate movable rate at 1.05 or higher. If the pin plate movable rate is too high, pin plates adjacent in the machine direction may interfere with each other. To avoid the interference between the pin plates, the pin plates adjacent in the machine direction need to be placed at a larger interval than conventional, which causes slack in the film and is not preferable. Thus, the pin plate movable rate can be set at 1.80 or lower to place the pin plates at a proper interval in the machine direction and to prevent the interference between the pin plates. Although description has been made in the example of film retainer 200 of the bearing moving type, the same applies to film retainer 100 of the slide moving type shown in FIG. 5 and the like.

The present inventors have conducted experiments for verifying the bowing reduction effect achieved by using the film retainer according to the present invention at a transverse direction stretching step in sequential stretching of films including machine direction and transverse direction stretching. In the following, the experimental results are described.

### [Preparation and Machine Direction Stretching of Polyimide Film]

N,N-dimethylacetamide was used as a solvent, and p-phenylenediamine (PPD) serving as a diamine component and 3,3′, 4,4′-biphenyltetracarboxylic dianhydride (s-BPDA) serving as an acid component were polymerized to provide a polyamic acid solution (polyimide precursor solution). The polyamic acid solution was casted on a support (stainless plate) and heated to provide a partially imidized self-supporting film. The self-supporting film was stretched by 7% in the machine direction at 120° C. with a machine direction stretching apparatus as shown in WO02011/125662 to provide a longitudinally stretched self-supporting film.

The machine direction stretching apparatus used in this case had the following configuration. Specifically, the stretching apparatus includes a feed mechanism for feeding a film, a take-in mechanism for taking in the film fed from the feed mechanism at a speed higher than the speed of the film fed from the feed mechanism, and two sets of film holding units placed at both ends of the film in a width (TD) direction between the feed mechanism and the take-in mechanism. The film holding unit includes a plurality of upper holding rollers placed in parallel at intervals in a film transport (MD) direction above a film transport path, and a plurality of lower holding rollers placed below the film transport path and opposite to the upper holding rollers to sandwich the film from above and below in coordination with the plurality of upper holding rollers. The upper holding rollers and the lower holding rollers are supported rotatably such that their rotational axes are inclined outward toward the film TD direction with respect to the film MD direction. For a range covered by each of the plurality of upper holding rollers holding the film in the film MD direction, the length of the upper holding roller, the interval between the upper holding rollers, and the inclination angle of the rotational axis of the upper holding roller toward the film TD direction are set such that two ranges adjacent in the film MD direction are in contact with or overlap each other.

### [Bowing Evaluation]

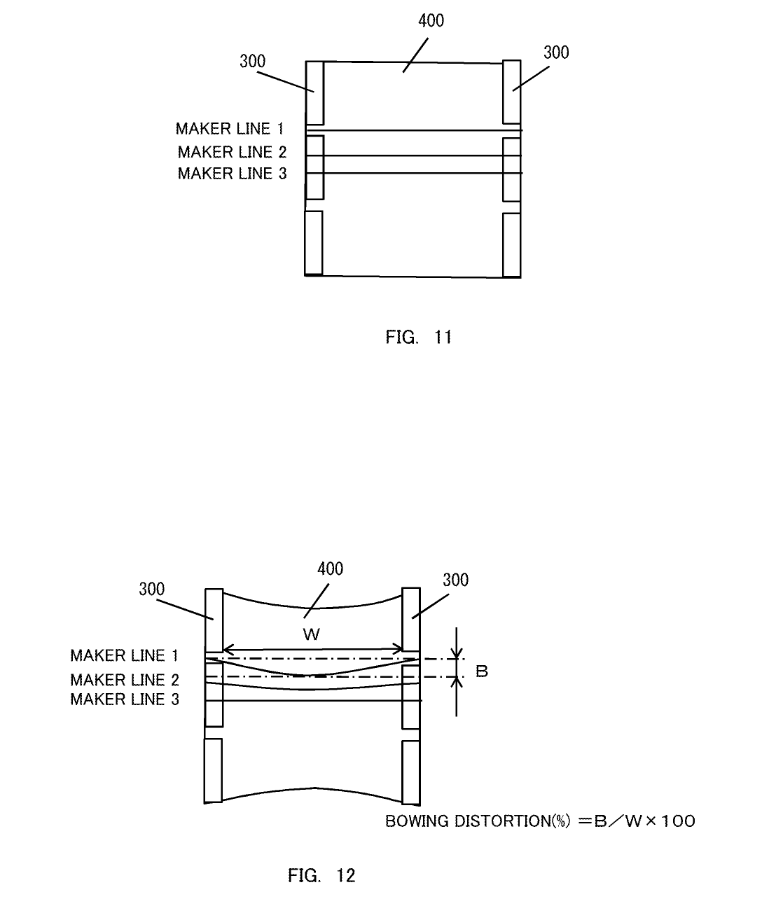

As shown in FIG. 11, both ends of resultant self-supporting film 400 in the transverse direction were attached to jig 300 of a film retainer including pin plates supported to be movable in the machine direction. The holding of self-supporting film 400 was performed by sticking a plurality of pins provided for the pin plate into self-supporting film 400. Three pin plates were placed in line on each side along the machine direction to be movable in the machine direction along a guide member corresponding to a base member. Pin plate 220 had a plurality of pins arranged in three lines in the transverse direction.

The following four types of film retainers were prepared, and bowing distortion was evaluated for each type.

### EXAMPLE 1

### Bearing Type (Two Bearings; See, for Example, FIG. 8A)

Two bearings 240 (grease-free bearing manufactured by NANKAI SEIKO CO., LTD., model: SS6900ZZ, outer diameter of 22 mm, inner diameter of 10 mm, thickness of 6 mm) was incorporated into base member 210 of case form having an opened upper face. Pin plate 220 (length of 70 mm, width of 20 mm, thickness of 3 mm) was placed at a predetermined position over base member 210. Pin plate 220 and bearing 240 were fastened by screws. To reduce sliding friction, sliding faces of base member 210 and bearing 240 were coated with tungsten disulfide. Pin plate 220 had a movable rate of 1.39.

### EXAMPLE 2

### Bearing Type (One Bearing; See, for Example, FIG. 8)

The film retainer was formed similarly to Example 1 except that one bearing 240 was incorporated into base member 210. Pin plate 220 had a movable rate of 1.68.

### EXAMPLE 3

### Sliding Type (See, for Example, FIG. 5, FIG. 7A, and FIG. 7B)

Film retainer 100 having two pin plates 120 as shown in FIG. 7A and FIG. 7B was used. Each of pin plates 120 had a length of 30 mm, a width of 24 mm, and a thickness of 3 mm. Pin plate 120 had a movable rate of 1.55.

### COMPARATIVE EXAMPLE 1

### Fixed-Type Pin Plate

For comparison with Examples 1 to 3, a jig having a fixed-type pin plate attached thereto was used to perform similar evaluations. The pin plate had a length of 95 mm, a width of 20 mm, and a thickness of 3 mm. Since the pin plate is of the fixed type, its movable rate was 1.00.

After self-supporting film 400 was held in the jig, as shown in FIG. 11, marker lines 1 to 3 in parallel to the transverse direction were drawn on self-supporting film 400. Self-supporting film 400 with the jig was put into an oven, the temperature was increased to 180° C., and then film 400 was slowly stretched by 10% to the transverse direction. After the stretching, the temperature was increased to 500° C. in the oven for thermal cure to provide a polyimide film. These operations were performed on two self-supporting films 400. The bowing distortion was calculated for marker lines 1 to 3 on the resultant polyimide films with an expression shown in FIG. 12, and was represented by the average values. The flatness of the obtained polyimide film was visually evaluated.

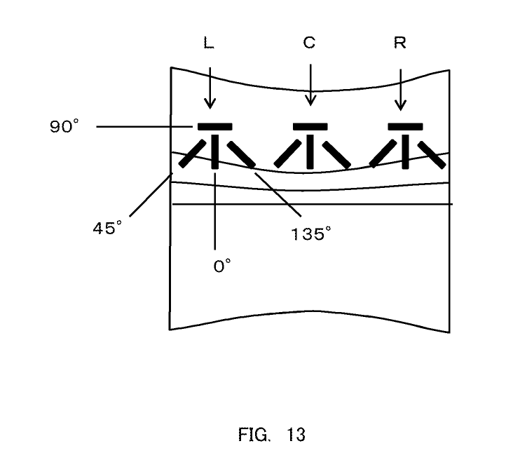

To see geometric bowing and property value bowing, samples were taken from both ends and the center of the polyimide film in the transverse direction near marker line 1 to measure the omnidirectional coefficient of thermal expansion (CTE). As shown in FIG. 13, the samples were cut from the film in left end (L), center (C), and right end (R) at angles of 0°, 45°, 90°, and 135°. For the coefficient of thermal expansion, the average coefficient of thermal expansion was measured at temperatures from 50° C. to 200° C. during a temperature rise at 20° C./minutes while a load of 39.2 N was applied to the sample by using a thermos-mechanical analyzer (manufactured by Seiko Instruments Inc., model: TMA/SS6100). CTE anisotropy was represented by an inclination angle (°) in the omnidirectional CTE. As the inclination angle is smaller, anisotropy of molecular orientation is smaller.

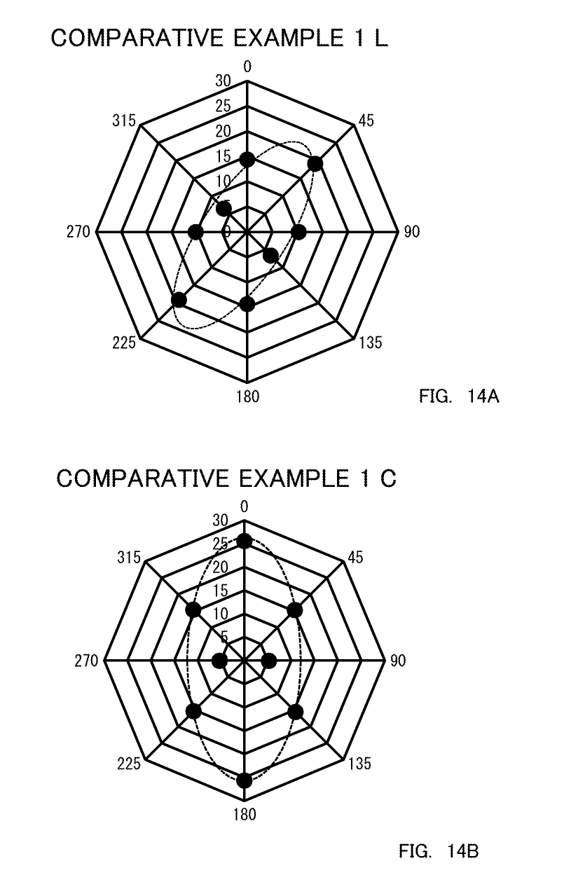

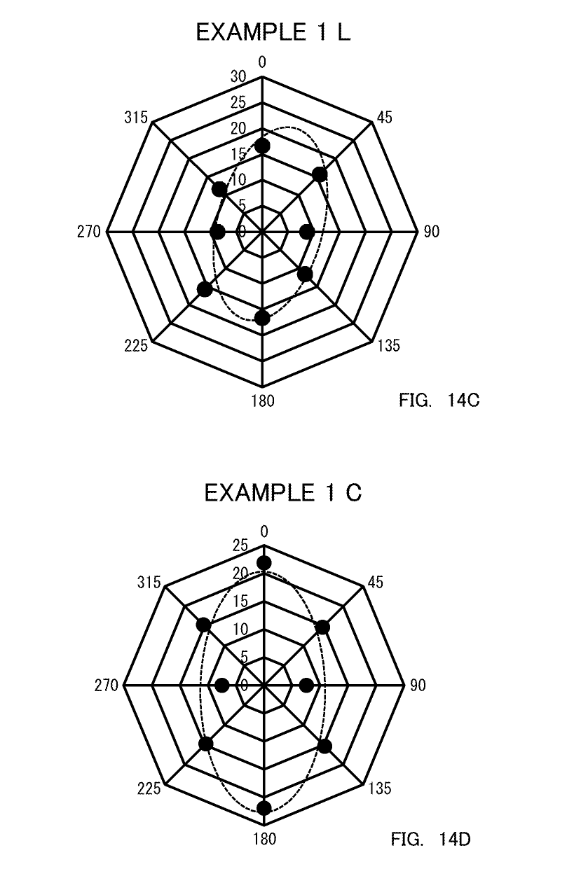

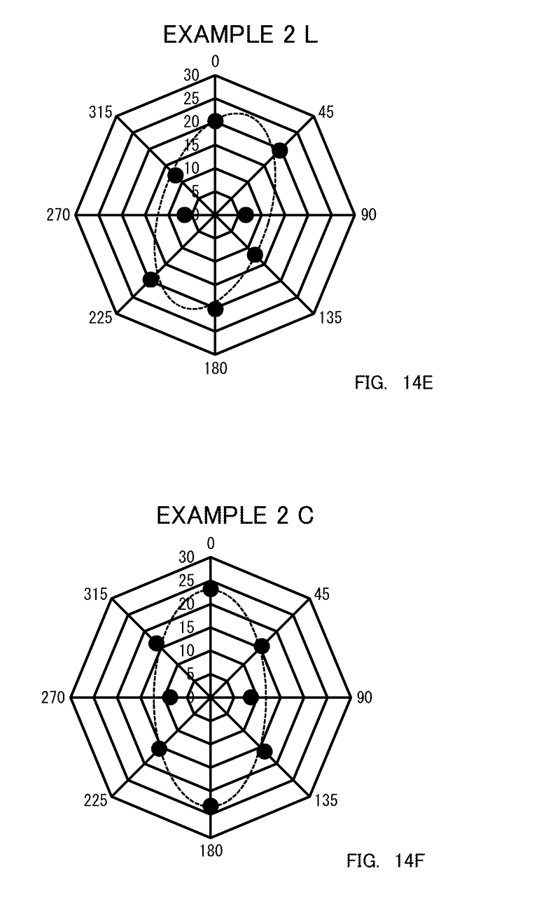

Table 1 shows the bowing distortion, flatness, and CTE in Examples 1 to 3 and Comparative Example 1. FIG. 14A to FIG. 14F show CTE radar charts of left end (L) and center (C) of the film in Examples 1, 2 and Comparative Example 1.

TABLE 1

| | | | bowing distortion | | | | |
|---|---|---|---|---|---|---|---|
| | | | (%) | | | | CTE |
| | | | marker | marker | marker | film | anisotropy |
| | pin plate | bearing | line 1 | line 2 | line 3 | flatness | (°) |
| Example 1 | movable | 2 | 0.9 | 0.6 | 0 | ◯ | 17 |
| | type | | | | | | |
| Example 2 | movable | 1 | 1.2 | 1.2 | 0.1 | ◯ | 21 |
| | type | | | | | | |
| Example 3 | movable | none | 2.3 | 1.5 | 0.5 | Δ | — |
| | type | | | | | | |
| Comparative | fixed | none | 3.1 | 1.8 | 0.4 | X | 45 |
| Example 1 | type | | | | | | |

With the results of Examples 1 to 3 and Comparative Example 1, it is seen that the use of the movable-type pin plate can reduce the difference in restraint force between the film ends and the film center to significantly reduce the bowing distortion and the anisotropy of molecular orientation at the film ends as compared with the use of the fixed-type pin plate. Since this can produce the polyimide film having uniform properties in the transverse direction, the product yields can be enhanced. In addition, the use of the movable-type pin plate can produce the polyimide film having better flatness as compared with the use of the fixed-type pin plate.

### REFERENCE SIGNS LIST

1 TENTER APPARATUS
2 DRIVE SPROCKET
3 DRIVEN SPROCKET
4 TENTER RAIL
5 TENTER CHAIN
41 GUIDE PLATE
51a, 51b INNER PLATE
52 BUSH
53, 73 ROTATOR
54a, 54b OUTER PLATE
55 COUPLING PIN
60 SHAFT MEMBER
61 BEARING
62 C WASHER
63 ATTACH PLATE
100, 200 FILM RETAINER
110, 210 BASE MEMBER
120, 220 PIN PLATE
130, 230 PIN
140 COIL SPRING
240 BEARING
250 ROD MEMBER
330 PIN (OF LANCET POINT TYPE)

1. A film retainer fixed to a pair of tenter chains included by a tenter apparatus, the tenter chain moving while holding a film at both ends in a transverse direction, comprising:
a base member fixed to the tenter chain; and
at least one pin plate supported on the base member to be movable in a direction of the movement of the tenter chain and provided with a plurality of protruding pins adapted to stick into the film for holding the film.

2. The film retainer according to claim 1, further comprising at least one elastic support member elastically supporting the pin plate on the base member in the movement direction of the tenter chain.

3. The film retainer according to claim 2, wherein the elastic support member is a coil spring.

4. The film retainer according to claim 1, wherein a plurality of the pin plates are placed at a space interval in the movement direction of the tenter chain.

5. The film retainer according to claim 1, wherein the pin plate includes a flat-plate portion provided with the plurality of protruding pins on a front face, a projecting portion protruding from a back face of the flat-plate portion, and an anchor portion extending in parallel to the flat-plate portion with a space interval in a thickness direction of the flat-plate portion across the projecting portion, and the base member includes a removal-preventing projecting portion extending between the flat-plate portion and the anchor portion.

6. The film retainer according to claim 1, further comprising at least one bearing rotatably supported on a back face side of the pin plate.

7. The film retainer according to claim 6, wherein the bearing is supported rotatably about an axis perpendicular to the movement direction of the pin plate.

8. The film retainer according to claim 6, wherein the bearing is a heat-resistant bearing.

9. The film retainer according to claim 1, wherein the pin is a pin of a lancet point type.

10. A tenter apparatus comprising:
a pair of tenter chains placed on both sides of a transport path of a film for transporting the film; and
a plurality of the film retainers according to claim 1, the film retainers being fixed to each of the pair of tenter chains.

11. A method of manufacturing a polyimide film, comprising:
a first step of casting a polyimide precursor solvent solution onto a support to provide a self-supporting film; and
a second step of heating the self-supporting film while the film is held,
the second step includes holding the self-supporting film as the film by using the tenter apparatus according to claim 10.
